(19) United States
(12) Patent Application Publication
(10) Pub. No.: US 2011/0258825 A1
(43) Pub. Date: Oct. 27, 2011

(54) Spray gun modifications for polymeric coating applicators

(76) Inventor: Matthew L. Johnston, Toms River, NJ (US)

(21) Appl. No.: 13/135,281

(22) Filed: Jun. 30, 2011

Related U.S. Application Data
(63) Continuation-in-part of application No. 11/065,178, filed on Feb. 24, 2005, now Pat. No. 7,248,080.
Application No. 11/065,178 is a continuation-in-part of application No. 11/065,179, filed on Feb. 24, 2005, now Pat. No. 7,330,108.
(60) Provisional application No. 61/456,100, filed on Nov. 1, 2010.

(51) Int. Cl. B23P 17/04

(52) U.S. Cl. 29/401.1

(57) ABSTRACT

A method of modifying a commercially available spray gun to enable its use in the application of polymeric coatings such as CARC paint incorporates the steps of removing the existing threaded bottle closure and replacing it with another bottle closure using procedures which maintain the integrity of the closure and the spray gun. The replacement bottle closure may be affixed to the spray gun using fasteners, adhesives or induction welding.

The present invention relates to modifications to a commercially available compressed air powered spray gun to enable its use to practice the inventions disclosed and claimed in my copending application Ser. Nos. 11/065,178 and 11/065,179, both filed Mar. 16, 2011, for applying polymeric coatings in military, commercial, or industrial applications.

### CROSS-REFERENCE TO RELATED APPLICATIONS

Applicant claims priority of U.S. Provisional Patent Application 61/456/100, filed Nov. 1, 2010. This application is a continuation in part of my copending application Ser. Nos. 11/065,178 and 11/065,179, both filed Mar. 16, 2011.

### SUMMARY OF THE INVENTION AND DESCRIPTION OF RELATED ART

The invention has specific utility in the military application of CARC, (chemical agent resistant coating). It is applied to military vehicles to provide resistance to chemical and biologic agents. The CARC coating permits vehicles and equipment to be more easily decontaminated in the event of exposure to chemical and biological agents.

In addition, CARC provides both visual camouflage and IR signature management. It is the IR signature management that is critical to maintain true camouflage. For example, by mimicking the IR signature of a heavily wooded environment, a vehicle having a woodland camo CARC finish is more difficult to identify because its IR signature appears to be the same as its surrounding environment.

As many passive missile guidance systems use IR signatures as a primary means of tracking targets, effective application of CARC coating enhances survivability. As will now be apparent, it is important to be able to “touch up” the CARC coating with touch up paint that possesses these same qualities.

As will now be understood, it is essential that the CARC coating maintain its chemical integrity so that when it is applied as a touch up, degradation of survivability will be minimized.

The present invention is a method for modifying a commercially available air powered spray gun applicator to allow a particular container for the CARC material to be attached. This enables the CARC material to be applied in a convenient manor using methods of filling the container which inhibit CARC exposure to any element which will cause it to degrade in its container.

One prior art device for applying a touch up CARC coating is shown and described in U.S. Pat. No. 7,338,27, issued Mar. 4, 2008, commonly assigned. That applicator uses a two component CARC coating requiring mixing before application. The prior use of two component CARC has thus limited the effectiveness and ease of use of aerosol spray applicators for CARC.

Another device is sold under the trademark PREVAL. While aerosol cans of coatings are commonplace, it has been difficult to put single component moisture cure CARC coating into a traditional aerosol container. The coating cures by reaction with moisture and it has proven difficult to exclude moisture during the filling of aerosol cans. It is however possible to use a can of aerosol propellant of the type sold under the trademark PREVAL to make a type of aerosol paint. The PREVAL sprayer unit includes a pressurized container with a plastic tube to take up the paint. The unit also has threads so that a plastic bottle containing a small quantity of paint may be attached to the PREVAL unit and sprayed by aerosol. The unit will not operate when held at an angle greater than 45° and clogs easily.

The applicator of the present invention may also be used to apply all types of polymeric coatings in other military applications as well as for commercial and industrial uses. The applicator works well with polymeric coatings such as urethane, epoxy, latex, acrylic, etc., regardless of water or solvent dispersions and regardless of single or dual component formats. The applicator is characterized by its atomization of polymeric coatings by means of co compressed air. The applicator is further characterized by its capacity to siphon fluid from an attached reservoir by means of compressed air being channeled through venturi constrictions thus creating an area of low atmospheric pressure within the nozzle of the spray unit and within a conjoined adjacent port leading to a fluid reservoir. The siphoning mechanism is characterized by the flow of compressed air acting upon an adjacent conjoining port leading to the fluid reservoir whereas the airflow creates a low-pressure area within the adjacent fluid reservoir port thus drawing the fluid towards and into the compressed airflow to achieve natural homeostasis. As the compressed air flow persists, a continuous state of pressure imbalance exists thus inducing a continued siphoning of liquid. The atomization is further characterized by the rapid acceleration and dispersion of the siphoned fluid within the compressed air stream thus being propelled though the exit orifice of said nozzle.

It is a principal object of the invention to provide a method and apparatus for modifying a commercially available trigger sprayer to enable its use to apply polymeric coatings such as CARC.

The above as well as further objects and advantages of the invention will become apparent from a review of the following specification reference being made to the accompanying drawings in which like reference numerals have been used to denote like parts.

### BRIEF DESCRIPTION OF THE DRAWINGS

FIG. 1 is a perspective view of the spray gun assembly before modifications;

FIG. 2 is a perspective view of the separate components of the assembly shown in FIG. 1;

FIG. 3 is a perspective view of a portion of FIG. 2;

FIGS. 4-5 are perspective view of the modified portion of FIG. 3;

FIG. 6 is a perspective view of the portion shown in FIGS. 4-5 further modified in accordance with my invention;

FIGS. 7-8 are perspective views of the portion shown in FIG. 6 prepared for mounting a new thread cap;

FIGS. 9-11 are perspective views of the portion of FIGS. 7-8 in a cast mold used in pilot hole drilling;

FIG. 12 is a perspective view of the thread cap after pilot hole drilling;

FIGS. 13-15 show the use of split-rivet fasteners; and

FIG. 16 are perspective views of the completed spray gun assembly after the modifications obtained by the method of my invention.

### DETAILED DESCRIPTION OF THE INVENTION

I have found that a certain trigger sprayer, namely the paint gun (air assist paint sprayer) models 62 and 63 available from Paasche Airbrush Co., Chicago, Ill., can be used to apply the polymeric coatings described above. The product described below has been tested with: CARC Single-Component polyurethane; CARC Two-Component polyurethane; waterborne epoxy primer; and solvent borne epoxy primer.

The preferred CARC liquid reservoir to be attached to the spray gun is:

Aluminum bottle # AG12040
Distributed by:
   Elemental Container
   860 Springfield Road South
   Union, N.J. 07083
   908-687-7720

### It is:

100% recyclable.
Seamless drawn 1050A grade aluminum,
Unlined interior,
Polished rolled 28 mm opening,
Smooth, unthreaded cylindrical neck,
Container neck overlayment is a single molded polypropylene continuous thread DIN-42 and clasping system,
Bottle opening is rolled over the polypropylene threads for added seal features and thread securing,
   This CARC liquid reservoir requires the following closure:
Screw Cap Seal: #40CAP00.
Distributed by:
   Elemental Container
   860 Springfield Road South
   Union, N.J. 07083
   908-687-7720
Single piece polypropylene construction,
DIN42 continuous thread,
Tamper evident clasping system,
Aluminized Mylar laminated solvent resistant
high density foam compression lining.

The present invention is a method of modifying the spray gun to enable it to be attached to the above container and screw cap seal.

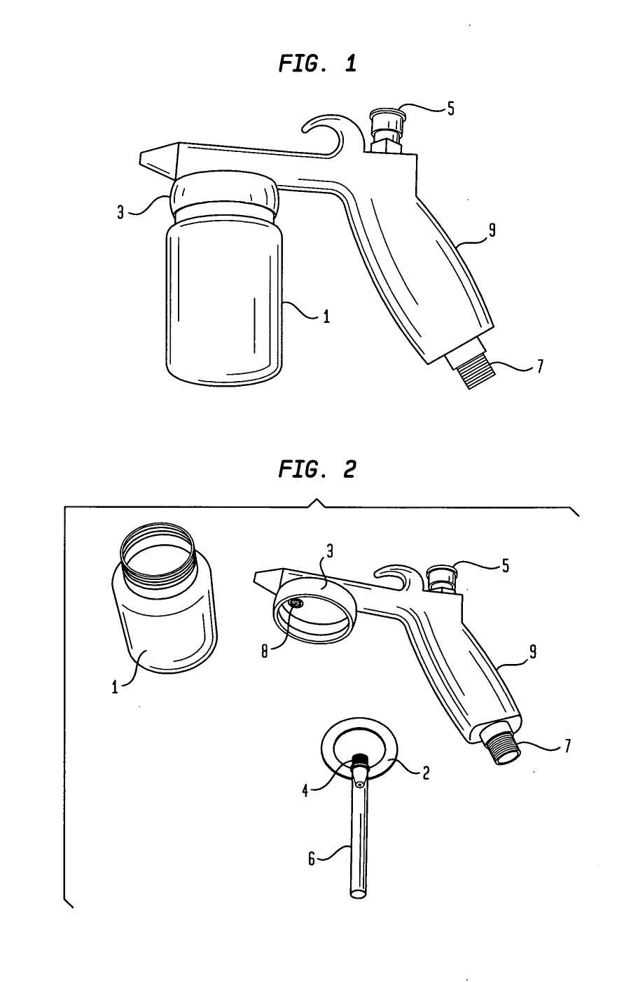

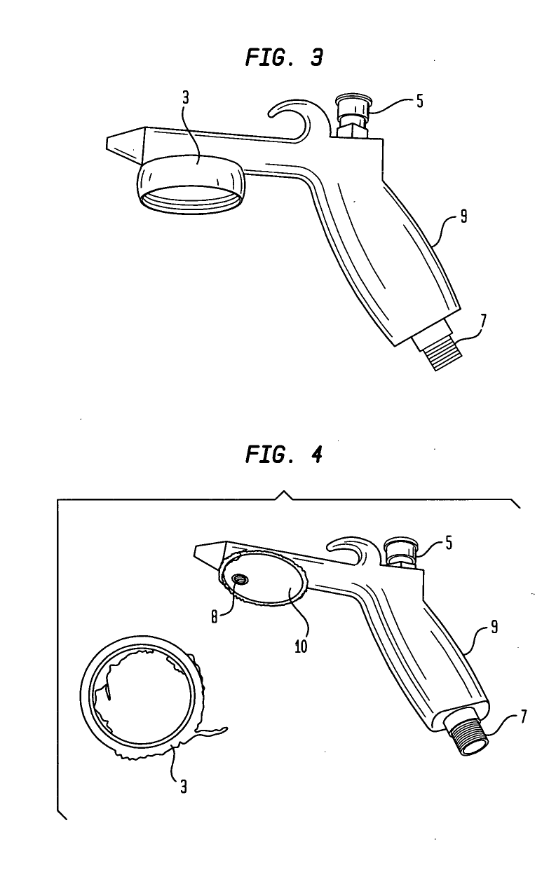

As shown in FIGS. 1-3, the Paasche Model 62 is supplied with the following components: spray gun 9, threaded brass adaptor 7, chrome plated air valve 5, plastic bottle 1, threaded plastic siphon tube nipple 4, plastic siphon tube 6, and cork gasket 2. The nipple 4 and tube 6 fits into the brass siphon inlet 8

All components other than the threaded brass air adaptor 7 and the chrome plated air valve 5 are separated. As shown in FIG. 4, the threaded portion 3 of the plastic bottle attachment area is removed as by cutting or sanding.

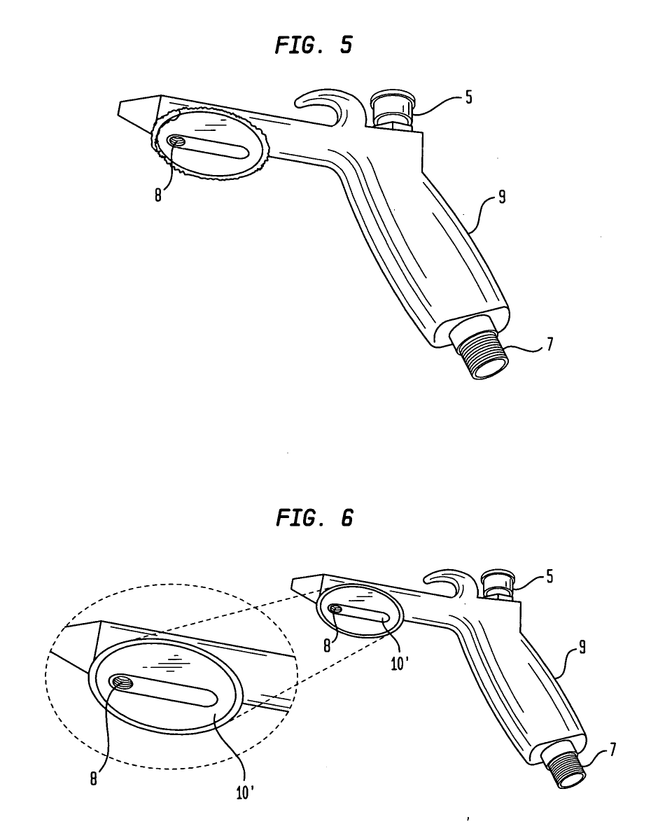

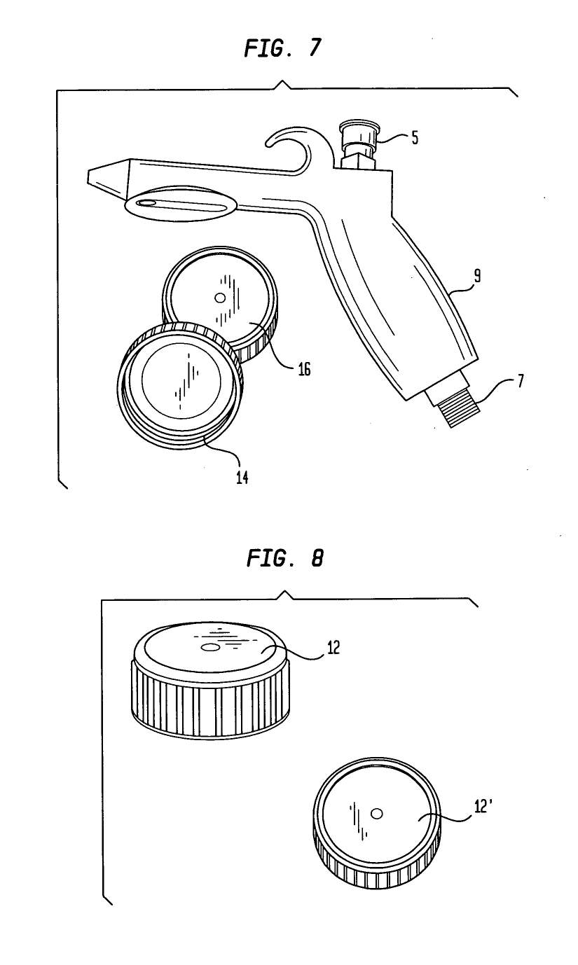

Referring now to FIGS. 5-6, with the threads removed, a rough-cut ridge or existing/excess material remains in addition to any inconsistencies in molding of the original plastic components. The rough cut portion is sanded flat and even with respect to the brass siphon inlet 8 to a smooth and uniform surface 10′. With reference to FIGS. 7-8, the existing thread cap shown at 14 and 16 is then prepared by fine sanding of its existing top surface profile 12 and 12′. Different methods may be employed to affix the new thread cap to the mounting surface. These include adhesive bonding, induction welding, or use of fasteners.

The preferred embodiment described herein uses split-rivet fasteners. Properly aligned holes for these fasteners are required which permeate both the mounting surface and the spray gun.

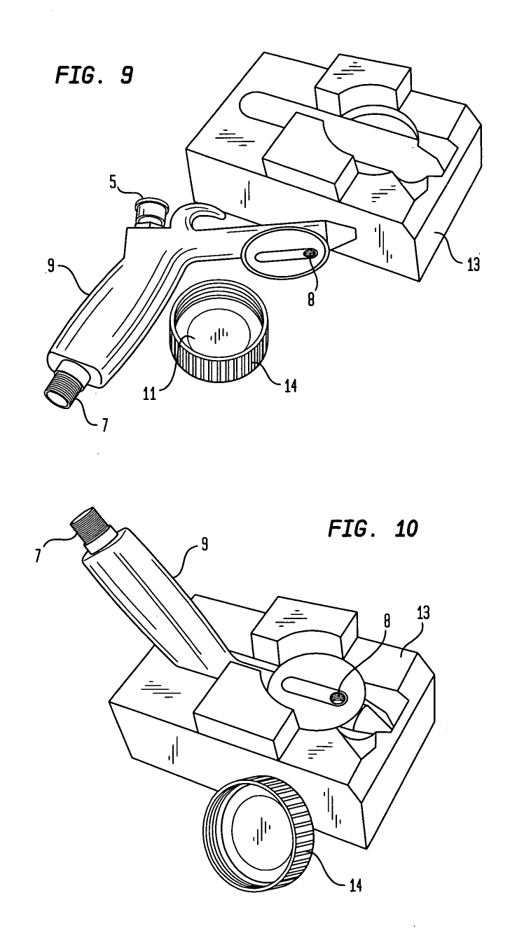

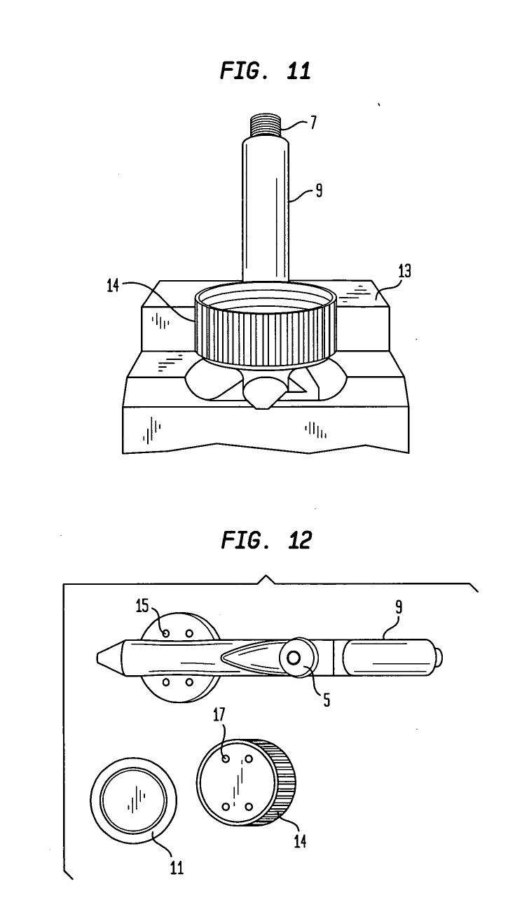

To assist in aligning multiple components, as shown in FIGS. 9-11, a cast mold 13 of the part assembly is used to ensure repetitive consistency and alignment of each part. The preferred replacement thread cap 14 has ridges formed thereon. These ridges have been superimposed within the cast mold to keep direction and placement consistent. Using the mold, the replacement thread cap 14 is consistently aligned and centered with respect to the spray gun. This permits pilot holes 15 and 17, shown in FIG. 12, to be drilled through the spray gun and the replacement thread cap, respectively.

Prior to drilling, all gasketing 11 within the replacement thread cap is removed to retain the integrity and functionality of the gaskets. Upon completion of the pilot hole drilling, the parts are then removed from the cast mold for assembly.

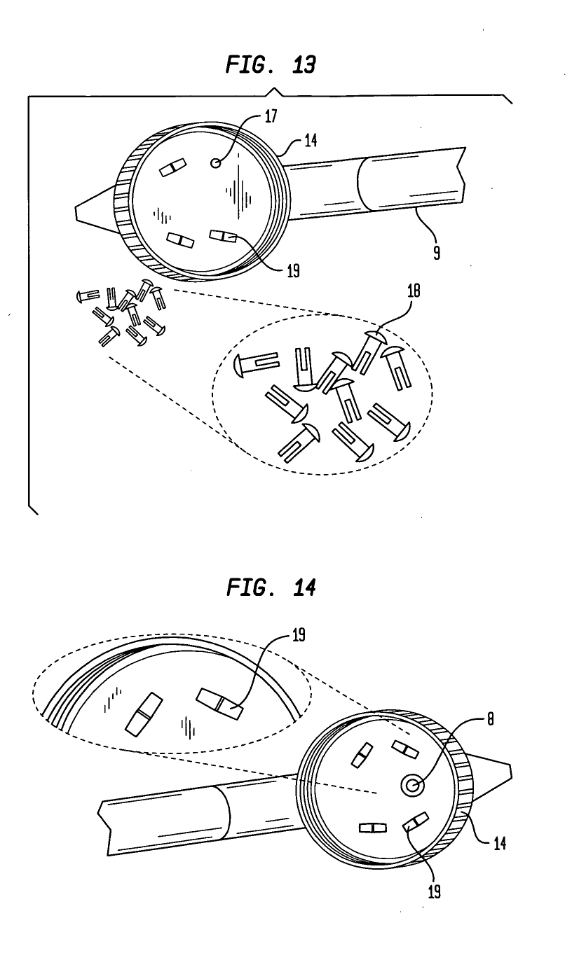

With reference to FIGS. 12-15, split rivets 18 are inserted through each pilot hole 15. Then, by visual alignment, the replacement thread cap 14 is aligned and mounted such that each of the split rivets permeates the corresponding pilot holes 17 in the replacement thread cap. The tines 19 of each split rivet are then separated.

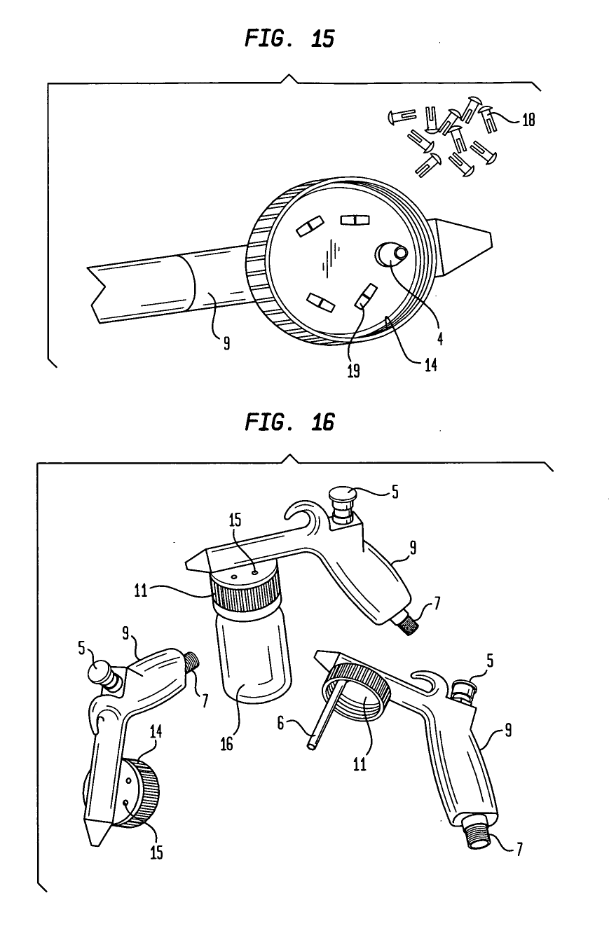

An orifice 4, FIG. 15, through the replacement thread cap 14 is formed by drilling or abrasion to permit access to the siphon port 8.

FIG. 16 shows the completed spray gun assembly. The siphon tube 6 and the gasketing material 11 are reattached thus enabling the new fluid reservoir 16 to be attached to the spray gun.

Further modifications to the methods and apparatus of the invention may be made without departing from the spirit and scope of the invention.

I claim:

1. The method of modifying a spray gun to enable the connection of a fluid reservoir thereto comprising the steps of:
a. removing the threaded portion of the existing fluid reservoir attachment by cutting or sanding;
b. sanding the remaining rough cut portion to produce a smooth flat surface;
c. affixing a new thread cap to the flat surface;
d. affixing a fluid reservoir to the new thread cap.

2. The method of claim 1 wherein said new thread cap is affixed using split-rivet fasteners.

3. The method of claim 2 further including the steps of drilling aligned holes in said flat surface and in said new thread cap; and inserting said split-rivet fasteners in said aligned holes.

4. The method of claim 3 wherein said spray gun is inserted into a cast mold for maintaining alignment during drilling of said holes.

5. The method of modifying a spray gun by replacing its existing threaded portion fluid reservoir attachment with another fluid reservoir attachment to enable the connection of a different fluid reservoir to said spray gun comprising the steps of:
a. removing the existing fluid reservoir, gasket, siphon tube nipple and siphon tube;
b. removing the existing threaded portion by cutting or sanding;
c. sanding the remaining rough cut portion to produce a smooth flat surface;
d. sanding the external surface replacement fluid reservoir attachment to produce a flat surface for attachment to said spray gun;
e. affixing said replacement fluid reservoir attachment to said spray gun;
f. replacing said siphon tube nipple and siphon tube and
g. affixing a replacement fluid reservoir to said replacement fluid reservoir attachment.

6. The method of claim 5 wherein said replacement fluid reservoir attachment is affixed to said spray gun using split-rivet fasteners.

7. The method of claim 6 further including the steps of drilling aligned holes in said smooth flat surface and in said replacement fluid reservoir attachment read cap; and inserting said split-rivet fasteners in said aligned holes.

8. The method of claim 6 wherein said spray gun is inserted into a cast mold for maintaining alignment during drilling of said holes.

9. The method of claim 5 wherein said replacement fluid reservoir is affixed to said spray gun by either adhesive bonding, induction welding, or fasteners.
